(19) United States
(12) Patent Application Publication
(10) Pub. No.: US 2008/0036560 A1
(43) Pub. Date: Feb. 14, 2008

(54) Electromagnet Apparatus

(75) Inventors: Avijit Saha, Kolkata (IN); Nilanjan Ray Chaudhuri, Kolkata (IN); Kalyana Sundaram, Bangalore (IN); Kathiravan Dhandapani, Bangalore (IN)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/463,030

(22) Filed: Aug. 8, 2006

(51) Int. Cl. H01H 51/22

(52) U.S. Cl. 335/78

(57) ABSTRACT

An apparatus for an electromagnet is disclosed. The apparatus includes a magnetizable stationary core having first and second end portions and a side portion, a magnetizable movable armature disposed proximate the core for establishing a magnetic circuit therebetween, and a permanent magnet disposed between the first portion of the core and a first end of the armature. The armature is movable between a first position and a second position, the first position resulting in the first end of the armature being proximate the first end of the core.

### BACKGROUND OF THE INVENTION

The present disclosure relates generally to electromagnetic contactors, and particularly to electromagnetic contactors with DC control circuits. As used for electrical contactors, an electromagnetic DC control coil provides no reactance component. Therefore, during the hold-on condition, only the coil resistance limits the coil current. As a result, the coil height of a DC control coil is much higher (almost double) the coil height of an AC control coil having the same voltage rating.

Use of permanent magnets within a DC control coil can assist in the pick-up and dropout of the contactor, reduce the current required to hold the contactor open, and therefore reduce the height of the DC control coil. Use of permanent magnets within a DC control coil has resulted in the need for multiple permanent magnets, complicated shapes of magnetic circuits associated with the permanent magnets, and attachment to an armature of a polar surface for electromagnet actuation. Accordingly, there is a need in the art for a DC electromagnet arrangement that overcomes these drawbacks.

### BRIEF DESCRIPTION OF THE INVENTION

An embodiment of the invention includes an apparatus for an electromagnet. The apparatus includes a magnetizable stationary core having first and second end portions and a side portion, a magnetizable movable armature disposed proximate the core for establishing a magnetic circuit therebetween, and a permanent magnet disposed between the first portion of the core and a first end of the armature. The armature is movable between a first position and a second position, the first position resulting in the first end of the armature being proximate the first end of the core.

### BRIEF DESCRIPTION OF THE DRAWINGS

Referring to the exemplary drawings wherein like elements are numbered alike in the accompanying Figures:

FIG. 1 depicts a front perspective view of an apparatus for an electromagnet in accordance with an embodiment of the invention;

FIG. 2 depicts a cross section view of an apparatus for an electromagnet in a first position in accordance with an embodiment of the invention;

FIG. 3 depicts a cross section view of an apparatus for an electromagnet in a first position in accordance with an embodiment of the invention;

FIG. 4 depicts a cross section view of the apparatus of FIG. 2 in a second position in accordance with an embodiment of the invention;

FIG. 5 depicts an enlarged cross section view of a portion of the apparatus shown in FIG. 2;

FIG. 6 depicts a cross section view of the apparatus of FIG. 2 with exemplary electromagnetic flux lines superimposed; and

FIG. 7 depicts an enlarged cross section view of the apparatus of FIG. 2 with exemplary permanent magnet magnetic flux lines superimposed.

### DETAILED DESCRIPTION OF THE INVENTION

An embodiment of the invention provides a bistable magnetic layout design for contactors using a DC control coil that allows for the reduction of DC control coil height. The magnetic circuit, as defined at least partially by a core, is modified by the inclusion of a permanent magnet, which aids in the pick-up and dropout of a contactor. Use of the permanent magnet allows use of a return spring with a lower spring constant. Use of a return spring with a lower spring constant reduces the required coil power consumption of the contactor, which accordingly allows use of a higher gauge (smaller diameter) coil conductor to thereby greatly reduce coil height.

In an embodiment, a single piece permanent magnet is used in the magnetic circuit. The permanent magnet is easy to manufacture and assemble, has a cylindrical shape with an inner bore, and rests on a coil bobbin surrounding an armature. The two flat surfaces of the cylinder define the two magnetic poles. The shape of the armature, defined in more detail below, enhances the operation of the electromagnet above and beyond other armatures that do not employ the features disclosed herein. In addition, the reduction of components reduces the overall cost of the apparatus, and provides for ease of assembly.

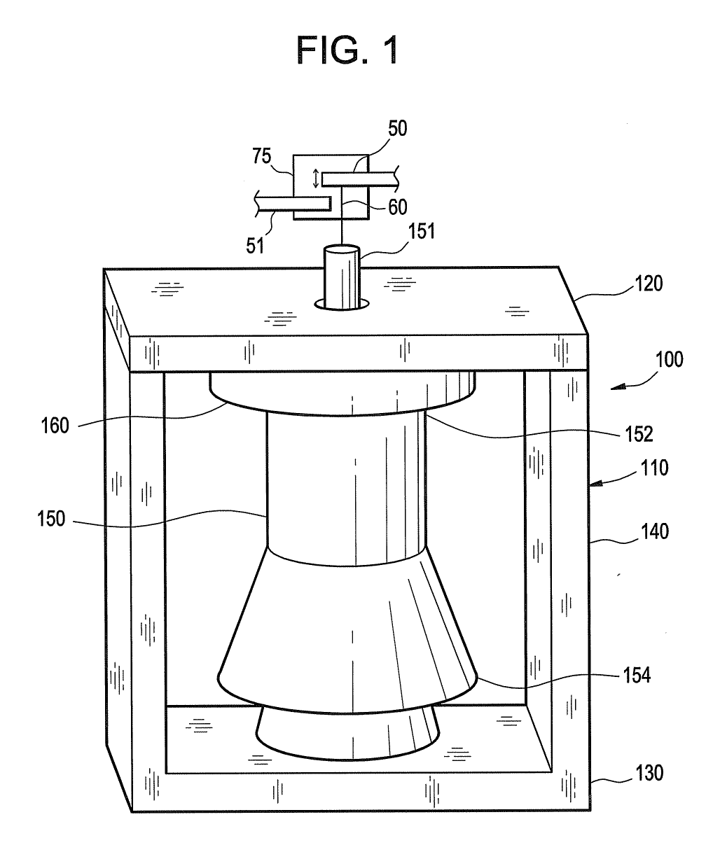

FIG. 1 is an embodiment of an apparatus 100 for an electromagnet. The exemplary embodiment includes a magnetizable stationary core 110, a magnetizable movable armature 150 disposed proximate the core 110, and a single permanent magnet 160. The core 110 has a first end portion (also herein referred to as a top) 120, a second end portion (also herein referred to as a bottom) 130, and a side portion 140. The armature 150 has a first end (also herein referred to as a top) 152, a second end (also herein referred to as a bottom) 154, and an extension arm 151 disposed proximate the top 152 of the armature 150. The extension arm 151 is connected via a linkage 60 to a moveable contact 50 disposed within a contact block 75 in a manner known in the art to transmit motion of the armature 150 to the moveable contact 50. The magnet 160 is disposed between the top 120 of the core 110 and the top 152 of the armature 150. A magnetic circuit is established between the core 110 and the armature 150. The armature 150 is movable between a first position and a second position, the first position resulting in the top 152 of the armature 150 being proximate the top 120 of the core 110, as depicted in FIG. 1. In response to the motion of the armature 150 to the second position, the movable contact 50 is driven to be in mechanical and electrical contact with a stationary contact 51, thereby providing a closed electrical circuit. While contact block 75, moveable contact 50, and stationary contact 51, are illustrated in reduced magnification with respect to apparatus 100, it will be appreciated that this is for illustration purposes only, and that the actual size of the components disclosed herein will be appropriately sized for the purposes disclosed herein.

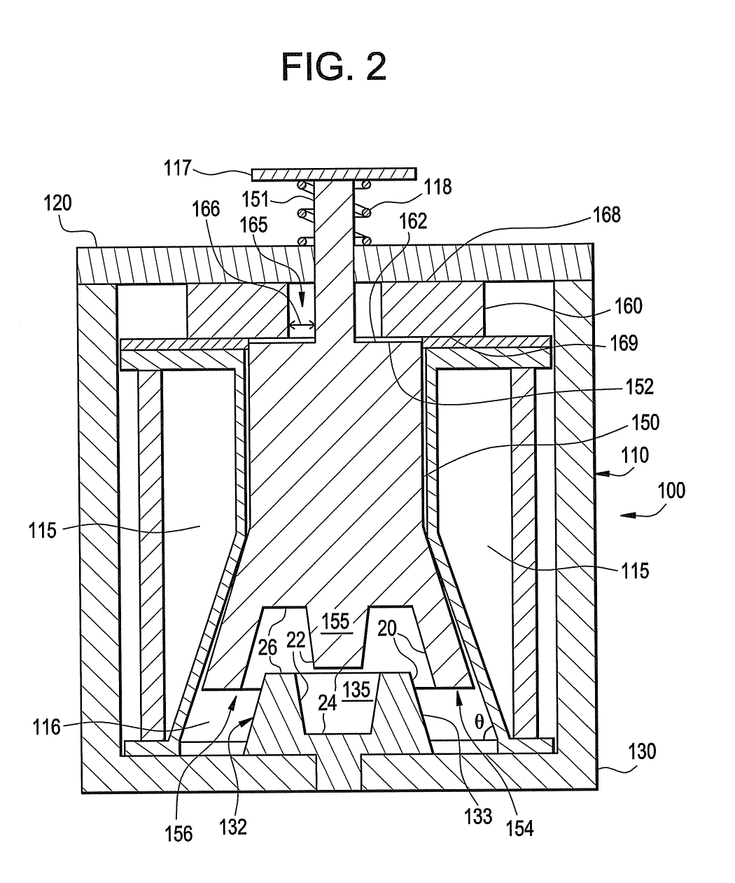

Referring now to FIG. 2, a cross section of an embodiment of the apparatus 100 is depicted. The permanent magnet 160 has a cylindrical shape including a bore 165. The magnetic poles of the magnet 160 are disposed on flat faces 168, 169 of the magnet 160. The extension arm 151 of the armature 150 is disposed within the bore 165. The bore 165 and the extension arm 151 are configured to provide an air gap 166 therebetween. The apparatus 100 further comprises a coil winding 115 having a central bore 116, the coil winding 115 disposed proximate the armature 150 and the core 110. The armature 150 is disposed within the bore 116 of the coil winding 115. It will be appreciated that although the conductors of the coil winding 115 are not physically depicted in FIG. 2, in an embodiment, they are disposed within the area generally indicated by the reference numerals 115. It will also be appreciated that such coil winding arrangements are known in the art and so further detailed illustration is deemed unnecessary. The core 110 comprises a projection 133 disposed at the bottom 130 of the core 110, the projection 133 being configured to transmit magnetic flux generated by the current passing through the coil winding 115 in response to energization of the coil windings 115 as will be described further below.

While an embodiment has been described having a single cylindrical permanent magnet with the magnetic poles on the flat faces, it will be appreciated that the scope of the invention is not so limited, and that the invention also applies to other permanent magnet arrangements, such as a plurality of stacked or segmented magnets, for example. While an embodiment has been described having a single stationary metallic projection as part of the stationary core, it will be appreciated that the scope of the invention is not so limited, and that the invention also applies to other arrangements of stationary cores, such as a multi-piece assembly comprising segments, for example.

In an embodiment, the armature 150 is biased toward the first position, as depicted in FIG. 2. The biasing force is provided by a compression spring 118 disposed between the flat plate 117 attached to the extension arm of the extension arm 151 of the armature 150 and the top 120 of the core 110. The biasing force is aided by the force of attraction between the flat surface 169 of permanent magnet and the top 152 of the armature 150. In response to the armature 150 being in the first position, the permanent magnet 160 and the armature 150 are disposed so as to define an air gap 162 between the top 152 of the armature 150 and the permanent magnet 160.

While an embodiment has been described using a compression spring disposed between the flat plate and the top of the core to provide a biasing force, it will be appreciated that the scope of the invention is not so limited, and that the invention also applies to other biasing means, such as an extension spring disposed between the top of the core and the top of the armature, or a torsion spring disposed between the side of the core and the armature, for example. While an embodiment has been depicted providing an air gap via physical separation, it will be appreciated that the scope of the invention is not so limited, and that the invention also applies to other structures that provide an air gap, such as a non-magnetic separator disposed between the armature and the magnet, for example.

In an embodiment, the bottom 154 of the armature 150 and the projection 133 define sets of opposing pole faces 20, 22, 24, 26 configured to nestle with each other in response to the armature 150 being in the second position. The bottom 154 of the armature 150 comprises a recess 156, the projection 133 comprises a projection 132, and the projection 132 is configured to nestle within the recess 156. In another embodiment, the bottom 154 of the armature 150 comprises a projection 155, the projection 133 comprises a recess 135, and the projection 155 is configured to nestle within the recess 135. In another embodiment, the bottom 154 of the armature comprises a first recess 156 and a first projection 155, the projection 133 comprises a second recess 135 and a second projection 132, the first projection 155 is configured to nestle within the second recess 135; and the second projection 132 is configured to nestle within the first recess 156. In another embodiment, the sets of opposing pole faces 20, 22, 24, 26 comprise tapered surfaces 20, 22, 24, 26 configured to nestle with each other. In an embodiment, the tapered surfaces 20, 22, 24, 26 have an included angle θ of about 60 degrees. As used herein, the term about refers to variation that may result from manufacturing, material, and design tolerances to accommodate a variety of desired operating characteristics.

While embodiments of the invention are described and illustrated having the bottom 154 of armature 150 tapered radially outward, and the projection 133 of stationary core 110 tapered radially inward, such that the armature 150 nestles over the projection 133, it will be appreciated that the scope of the invention is not so limited, and that the tapering may be reversed such that the armature nestles within the projection.

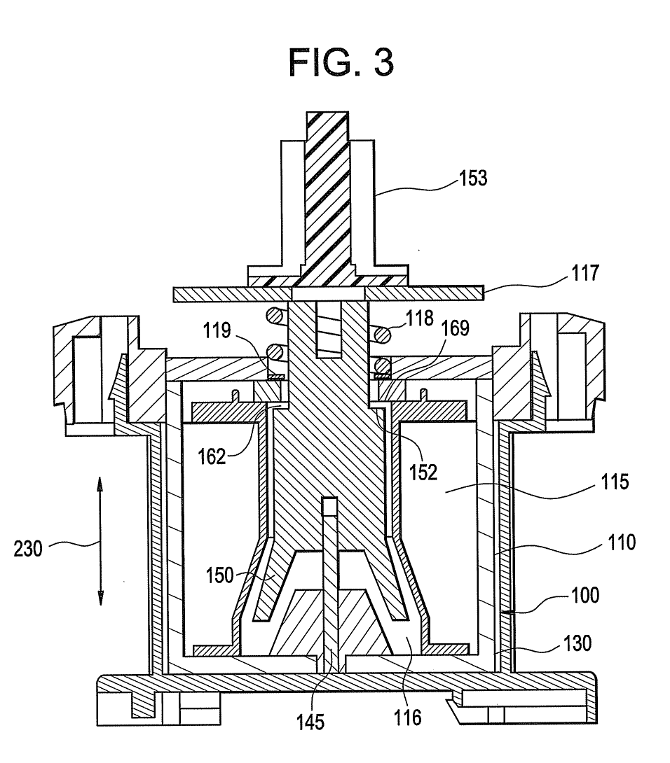

Referring now to FIG. 3, a cross section of an embodiment of the apparatus 100 is depicted. In an embodiment, a non-magnetic pin 145, is used to provide guidance of the armature 150 by improving alignment between the armature 150 and the bore 116 of the coil winding 115. The pin 145 is disposed within both the bottom 130 of the core 110 and the armature 150. The pin is attached to one of the core 110 and the armature 150, and is aligned with a direction of motion of the armature 150, as shown generally by direction line 230. Additionally, a moving carrier 153 is provided to transmit the motion of the armature 150.

In an embodiment, the armature 150 is biased toward the first position, as depicted in FIG. 3. The biasing force is provided by a compression spring 118 disposed between the flat plate 117, attached to the extension arm 151 of armature 150, and a plastic plate 119 placed over the top of the permanent magnet 160. The biasing force is aided by the force of attraction between the flat surface 169 of permanent magnet and the top 152 of the armature 150. In response to the armature 150 being in the first position, the permanent magnet 160 and the armature 150 are disposed so as to define an air gap 162 between the top 152 of the armature 150 and the permanent magnet 160.

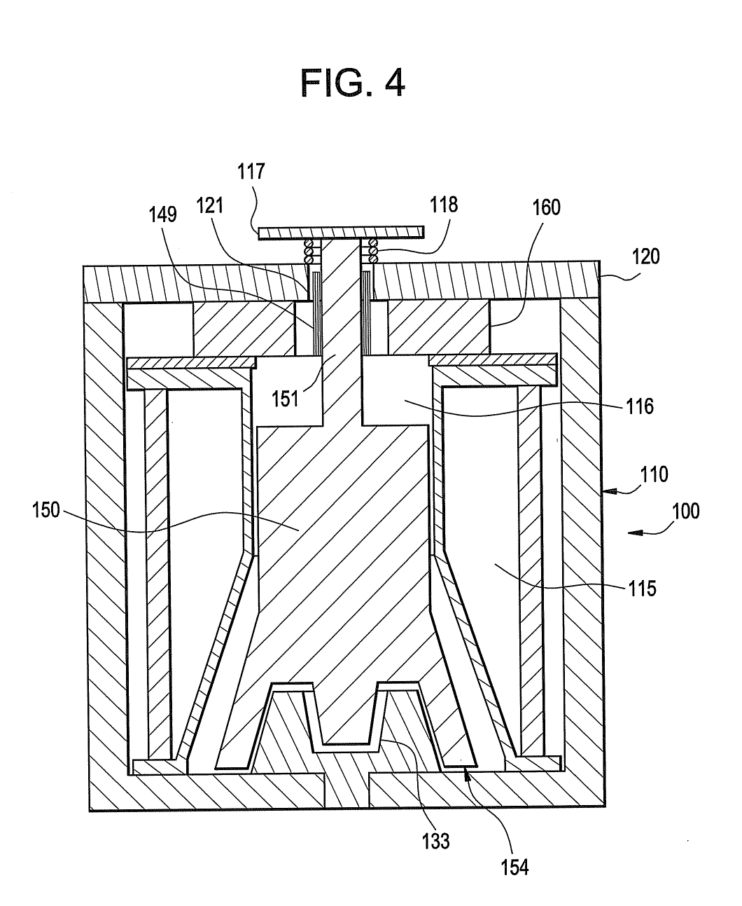

Referring now to FIG. 4, an exemplary embodiment of the apparatus 100 is depicted with the armature 150 in the second position, resulting in the bottom 154 of the armature 150 being proximate the projection 133. In an embodiment, in response to the coil winding 115 being energized, it generates a magnetic flux that traverses the magnetic circuit creating an attractive force between bottom 154 of the armature 150 and the projection 133, and also between the flat plate 117 and the top of the core 120, to cause the armature 150 to shift toward the second position. In an embodiment, a cover 149 will separate the extension arm 151 from an opening 121 in the top 120 of the core 110. The cover 149 comprises a non-magnetic material.

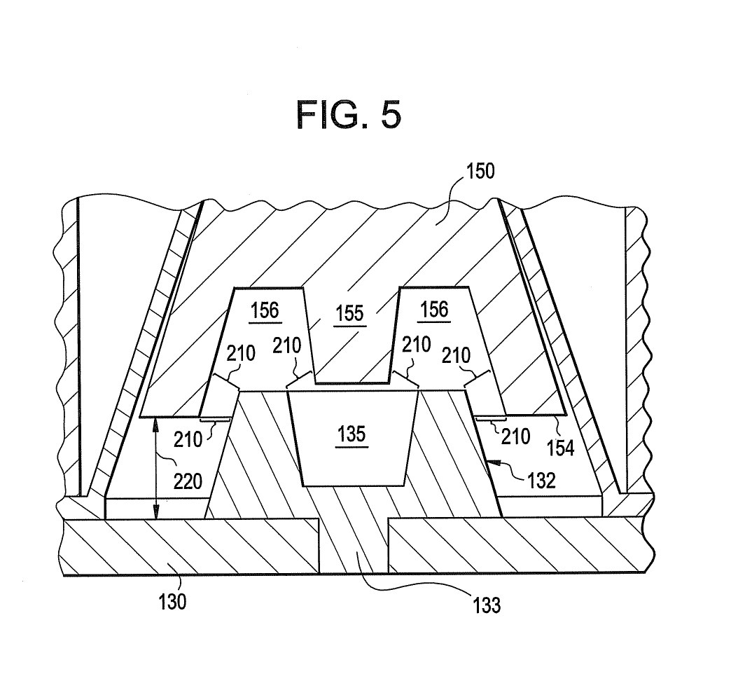

Referring now to FIG. 5, an enlarged embodiment of the bottom 154 of the armature 150 and the projection 133 is depicted. The bottom 154 of the armature 150 is configured, in conjunction with the projection 133 to provide a reduced air gap 210. It may be appreciated that absent the configuration of the bottom 154 of the armature 150 and the projection 133 depicted in FIG. 5, in response to the armature 150 being disposed in the first position, the air gap between the bottom 154 of the armature 150 and the bottom 130 of the core 110 would be the same as the displacement of the armature 150 from the first position to the second position, as indicated by reference numeral 220. It may be further appreciated that the configuration of the bottom 154 of the armature 150, in conjunction with the projection 133, provides an increase in the area of the respective surfaces of the bottom 154 and the projection 133, greater than what would be provided absent the individual projections 132, 155 and the individual recesses 135, 156. The reduced effective air gap 210, and the increased surface area of the opposing pole faces due to the angular profile, results in a lower magnetic reluctance in the magnetic circuit, which in turn provides for an increase in the electromagnetic force to ensure proper pickup of the contactor in response to the coil windings 115 being in the energized state.

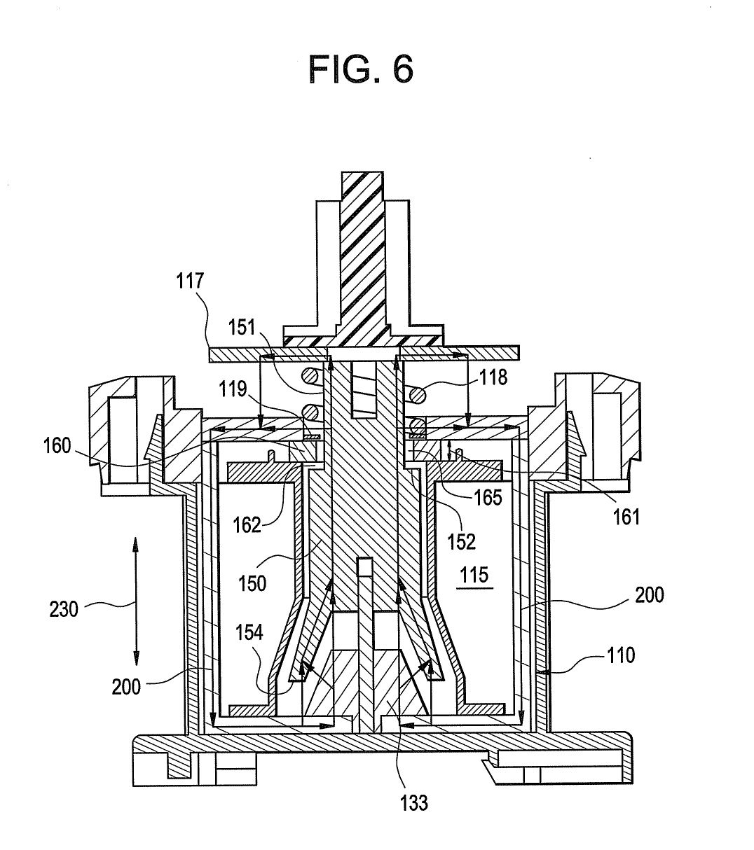

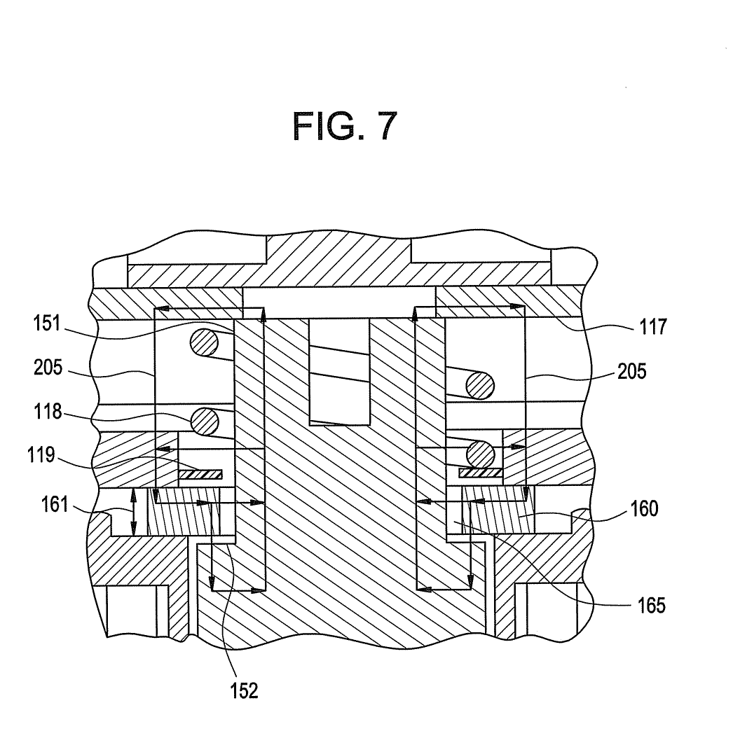

Referring now to FIGS. 6 and 7, an embodiment of the apparatus 100 is depicted with exemplary electromagnet flux lines 200 and permanent magnet flux lines 205. In the embodiment depicted in FIG. 6, the armature 150 is shown in the first position, with the top 152 disposed proximate the magnet 160, in response to the coil winding 115 being in a non-energized state. It may be appreciated that the armature 150 is biased to the first position by a combination of the spring force exerted by the compression spring 118 and the attractive magnetic force provided by the magnet 160. The contribution of the magnet 160 to the biasing force allows use of a smaller, lower force spring 118.

In an embodiment, it is desirable to size the bore 165 of the permanent magnet 160 so as to prevent any local circulation of flux between the magnet 160 and the extension arm 151 of the armature 150. Also, it is desirable to size the depth 161 of the permanent magnet 160 so as to prevent any local circulation of flux between the magnet 160 and the top 130 of the core 110.

In an embodiment, in response to the coil windings 115 being in an energized state, an attractive electromagnetic force between the armature 150 and the projection 133 will be created, as well as an attractive electromagnetic force between the flat plate 117 and the top 120 of the core 110. The increase in mating surface area between the projection 133 and the armature 150 discussed above provides for an increase in the attractive force. The coil windings 115, armature bottom 154, projection 133, and the flat plate 117 are configured such that this attractive force will be greater than the sum of the forces provided by the spring 118 and the permanent magnet 160 to bias the armature 150 to the first position. Accordingly, in response to the coil windings 115 being in an energized state, the armature 150 shifts toward the second position (as depicted in FIG. 4).

As the armature begins to move from the first position in FIGS. 2, 4, and 5 toward the projection 133, the air gap 162 between the magnet 160 and the top 152 of the armature 150 will increase, thereby causing the contribution of the magnet 160 to bias the armature 150 toward the first position to decrease. Additionally, as the bottom 154 of the armature 150 approaches the projection 133, the force generated by the magnet 160 as transmitted by the magnetic circuit of the core 110 begins to attract the bottom 154 of the armature 150 to the projection 133, and the force between the flat plate 117 & the top core 120 is also increased.

Because the magnet 160 allows for the use of a smaller spring 118, as described above, there is a reduced biasing force opposing the disposition of the armature 150 in the second position in response to the coil windings 115 being in the energized state. Furthermore, as described above, in response to the armature 150 moving toward the second position, the magnet 160 provides a force to attract the bottom 154 of the armature 150 toward the projection 133. The magnet 160 also provides an attractive force between the flat plate 117 and the top 120 of the core 110. Therefore, the current flow through the coil windings 115 required to maintain the armature 150 in the second position is reduced. As the current flow through the coil winding 115 conductor is reduced, a higher gauge (smaller diameter) conductor may be used for the coil windings 115. Use of smaller diameter conductor within the coil windings 115 likewise allows the coil to be configured having smaller overall dimensions.

An embodiment of the invention provides a bistable magnetic layout design for contactors using DC control coils. The design allows for the reduction of DC control coil height. The embodiment includes the magnetic circuit having the cylindrical shaped movable armature 150 with the extension arm 151. The extension arm 151 moves through the bore 165 of the permanent magnet 160. The permanent air gap 162 between the permanent magnet 160 and the armature top 152 is kept when the contacts 50, 51 of the contactor are open. This ensures that during the pick-up condition the electromagnetic force on the armature 150 is greater than the sum of the return spring force and the permanent magnet force. The bottom 154 of the armature 150 is tapered to increase the vertical component of the electromagnet force.

The fixed core 110 consists of a U shaped magnetic circuit, a top plate, and the tapered projection 133 with an inner cutout axially aligned with the armature 150. The enhanced polar surface of the armature 150, the inner-core of the armature 150, and the projection 133 in the fixed core 110 ensure enough resultant magnetic flux to provide proper pick up of the contactor. As the armature 150 approaches the tapered projection 133 during the pick-up condition, the permanent magnet 160 also aids the electromagnet coil windings 115 in pick-up.

During the dropout condition, the return spring 118 provides the initial bias. As the armature 150 travels a certain distance toward the projection 133, the permanent magnet 160 aides it in dropout. Thus the return spring 118 can have a lower spring constant for dropout, reducing the required coil power consumption of the contactor, and thereby allowing use of smaller diameter coil conductor to reduce coil height.

As disclosed, some embodiments of the invention may include some of the following advantages: ability to reduce the size of the biasing spring; ability to reduce coil power consumption; ability to reduced the size of the coil; ability to reduce apparatus cost; and ease of assembly.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An apparatus for an electromagnet, the apparatus comprising:
a magnetizable stationary core having first and second end portions and a side portion;
a magnetizable movable armature disposed proximate the core for establishing a magnetic circuit therebetween, the armature movable between a first position and a second position, the first position resulting in a first end of the armature being proximate the first end of the core; and
a permanent magnet disposed between the first portion of the core and the first end of the armature.

2. The apparatus of claim 1, wherein:
in response to the armature being in the first position, the permanent magnet and the armature are disposed so as to define an air gap therebetween.

3. The apparatus of claim 1, wherein:
the armature is biased toward the first position.

4. The apparatus of claim 1, further comprising:
a coil winding disposed proximate the armature and core, which when energized generates a magnetic flux that traverses the magnetic circuit.

5. The apparatus of claim 4, wherein:
the coil winding has a bore; and
the armature is disposed within the bore.

6. The apparatus of claim 1, wherein:
the second end of the armature and the second end portion of the core define opposing pole faces configured to nestle with each other in response to the armature being in the second position.

7. The apparatus of claim 6, wherein:
the second end of the armature comprises a recess;
the second end portion of the core comprises a projection; and
the projection is configured to nestle within the recess.

8. The apparatus of claim 6, wherein:
the second end of the armature comprises a projection;
the second end portion of the core comprises a recess; and
the projection is configured to nestle within the recess.

9. The apparatus of claim 6, wherein:
the second end of the armature comprises a first recess and a first projection;
the second end portion of the core comprises a second recess and a second projection;
the first projection is configured to nestle within the second recess; and
the second projection is configured to nestle within the first recess.

10. The apparatus of claim 6, wherein:
the opposing pole faces comprise tapered surfaces configured to nestle with each other.

11. The apparatus of claim 10, wherein:
the tapered surfaces have an included angle of about 60 degrees.

12. The apparatus of claim 1, wherein:
the permanent magnet comprises a bore; and
the first end of the armature comprises an extension arm disposed within the bore with an air gap therebetween.

13. The apparatus of claim 1, wherein:
the permanent magnet is a single permanent magnet.

14. The apparatus of claim 1, wherein:
the permanent magnet is cylindrical, comprising a bore.

15. The apparatus of claim 14, wherein
the permanent magnet comprises magnetic poles that are disposed on the flat surfaces.

16. The apparatus of claim 4, wherein:
the core comprises a metallic projection configured to transmit magnetic flux generated in response to energization of the coil windings.

17. The apparatus of claim 16, wherein:
the metallic projection comprises a single metallic projection.

18. The apparatus of claim 1, wherein:
in response to the armature being in the first position, the permanent magnet and the armature are disposed so as to define a first air gap therebetween;
the permanent magnet comprises a bore; and
the first end of the armature comprises an extension arm disposed within the bore with a second air gap therebetween.

19. The apparatus of claim 1, further comprising:
a non-magnetic pin, the pin aligned with a direction of motion of the armature;
wherein the pin is disposed within both the core and the armature;
wherein the pin is attached to one of the core and the armature.
